(19) United States
(12) Patent Application Publication
(10) Pub. No.: US 2026/0293915 A1
(43) Pub. Date: Oct. 1, 2026

(54) APPARATUS AND METHOD FOR FORMING A COVER LAYER FOR A CAKE

(71) Applicant: Daniel DAVIES, Welshpool (GB)

(72) Inventor: Daniel DAVIES, Welshpool (GB)

(21) Appl. No.: 19/472,657

(22) PCT Filed: Mar. 28, 2024
(86) PCT No.: PCT/GB2024/050863

§ 371 Date: Oct. 4, 2025

(30) Foreign Application Priority Data
Apr. 4, 2023 (GB) 2304960.4

(51) Int. Cl. A21C 15/00; A21D 13/24; A21D 13/80

(52) U.S. Cl. CPC A21C 15/002; A21D 13/24; A21D 13/80

(57) ABSTRACT

An apparatus for forming a cover layer (22′) for a cake base (60) comprises a concave mould (12) comprising inner walls (26) defining a moulding surface, and an expandable enclosure (18) which can be positioned in the mould. The expandable enclosure (18) comprises a flexible, resiliently deformable wall defining an internal cavity and a plurality of discrete bodies, e.g. spheres (56) are retained within the internal cavity of the expandable enclosure (18). A displacement member (40) projects into the interior of expandable enclosure (18) and is reversibly movable within the enclosure (18) to displace the discrete bodies (56) and thereby reversibly expand the flexible, resiliently deformable wall of the expandable enclosure (18).

The present invention relates to an apparatus and method for forming a cover layer, e.g. a decorative cover layer, for a cake base.

The present invention also includes a method of covering a cake base using a cover layer formed by the method of the present invention.

In order to produce a decorative cake, a cake base, typically made from a baked sponge, is prepared and a decorative layer is then normally applied to the base. The decorative layer can be formed from a spreadable material such as cream, buttercream or a chocolate cream or can be formed from a layer of icing which is draped over the cake base and manipulated manually to contact the cake base, with the excess icing material being trimmed off.

Cakes with a decorative layer of spreadable material lend themselves to mass production, as predetermined amounts of spreadable material can be discharged automatically onto preformed cake bases and subsequently smoothed off automatically with minimal manual intervention by displacing the cake base with respect to a spatula or similar levelling device.

However, the mass production of decorative cakes having a layer of icing or fondant still requires significant manual intervention. Oversized sheets of icing or fondant material are draped over similarly-shaped cake bases but each sheet must then be pressed manually into contact with the associated cake base, before any excess icing or fondant material is manually trimmed off.

Moreover, while the process is relatively straightforward with a cake base of a simple shape, such as a circular or rectangular base, it is significantly more complicated with more complicated cake bases, for example for a cake intended to resemble an animal. In addition, the surface of the layer of icing or fondant tends to be smooth, and any texture or pattern on the surface must either be applied subsequently or additional decoration may be applied subsequently to the smooth top layer of the icing or fondant, both of which further increase the requirement for manual intervention.

In accordance with a first aspect of the present invention, an apparatus for forming a cover layer for a cake base comprises:
a concave mould comprising inner walls defining a moulding surface;
an expandable enclosure positionable into the mould and comprising a flexible, resiliently deformable wall defining an internal cavity;
a plurality of discrete bodies retained within the internal cavity of the expandable enclosure; and
a displacement member projecting into the interior of expandable enclosure and being reversibly movable within the enclosure to displace the discrete bodies and thereby reversibly expand the flexible, resiliently deformable wall of the expandable enclosure.

The present invention allows a sheet of mouldable icing or fondant to be moulded quickly and repeatedly into a shape defined by the mould, which can then be used to cover a cake base. The invention therefore lends itself to mass production of decorated cakes.

Moreover, the use of discrete bodies in the expandable enclosure which are pushed outwardly as the displacement member moves further into the expandable enclosure expands the wall of the enclosure so that the sheet of mouldable icing is pressed firmly into contact with the moulding surface of the mould across the whole of the moulding surface. This allows detailed surface features from the moulding surface of the mould to be moulded into the mouldable sheet of icing.

Preferably, the apparatus comprises a mould support comprising a recess for releasably receiving and supporting the mould.

A mould support helps to position the mould securely and accurately, which assists in accurate and reliable reproduction of the moulded sheet of icing.

Preferably, the outer surface of the concave mould and the walls of the recess of the mould support are shaped and dimensioned complementarily with each other.

This ensures that the mould is supported across the whole of its exterior, and assists in transferring the surface features of the moulding surface to the moulded sheet of icing.

Preferably, when the concave mould is received in the recess of the mould support, the outer surface of the concave mould is in contact with the walls of the recess of the mould support.

Preferably, the concave mould is resiliently deformable.

A resiliently deformable mould assists in removal of the moulded sheet of icing from the mould with minimal damage to the icing.

For example, the concave mould may comprise silicone rubber.

There may be a plurality of substantially identical discrete bodies retained within the internal cavity of the expandable enclosure.

Alternatively, there may be discrete bodies of different shapes and/or dimensions.

The apparatus may comprise a plurality of spherical discrete bodies.

Preferably, the expandable enclosure is elongate when undeformed.

An elongate expandable enclosure facilitates receipt in the mould prior to the sheet of icing being moulded.

The expandable enclosure may be generally frustoconical when undeformed, and may comprise a rounded head.

The apparatus may comprise a movable carriage on which the expandable enclosure is mounted.

The expandable enclosure may be mounted on an undersurface of the movable carriage.

Preferably, the carriage is movable to position the expandable enclosure into the mould.

Preferably, the carriage is movable in both directions along a vertical axis.

The displacement member is preferably mounted on the movable carriage.

The displacement member may pass into the internal cavity of the expandable enclosure through an aperture in the movable carriage.

The displacement member may be slidably mounted in the aperture in the movable carriage.

The displacement member may conveniently be generally cylindrical.

The displacement member may comprise a rounded head which projects into the internal cavity of the expandable enclosure.

A rounded head helps to displace the discrete bodies smoothly and evenly within the expandable enclosure when the displacement member moves further into the enclosure, and assists in producing an even expansion of the expandable enclosure.

In accordance with a second aspect of the present invention, a method of forming a cover layer for a cake using the apparatus of the present invention comprises:
positioning a layer of mouldable cover material within the concave mould;
positioning the expandable enclosure within the mouldable cover material;
moving the displacement member to displace the discrete bodies and thereby expand the flexible, resiliently deformable wall of the expandable container, thereby engaging the layer of mouldable cover material and pressing it into contact with the moulding surface of the mould to form a moulded layer of cover material;
withdrawing the displacement member to allow the flexible, resiliently deformable wall of the expandable container to retract out of engagement with the moulded layer of cover material; and
removing the expandable enclosure from within the moulded layer of cover material.

The present invention also includes a method of covering a cake base, comprising forming a cover layer for a cake in accordance with the second aspect and positioning a cake base within the moulded decorative layer of cover material.

The cake base may be positioned in the moulded cover layer while the moulded cover layer is in the mould and the mould may be subsequently removed.

The cake base and moulded cover may be cooled.

By way of example only, a specific embodiment of the present invention will now be described with reference to the accompanying drawings, in which:

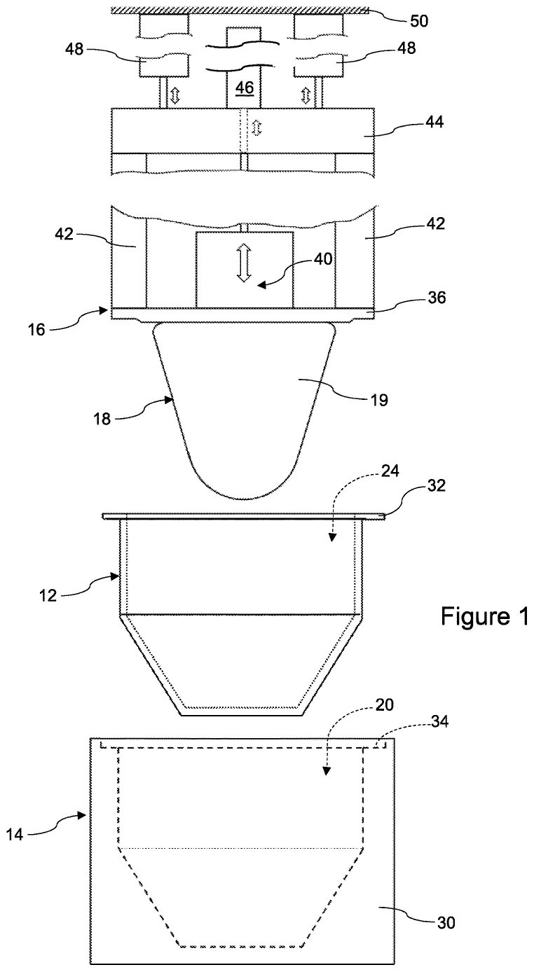

FIG. 1 is a side view of an embodiment of apparatus for producing a moulded decorative layer for a cake;

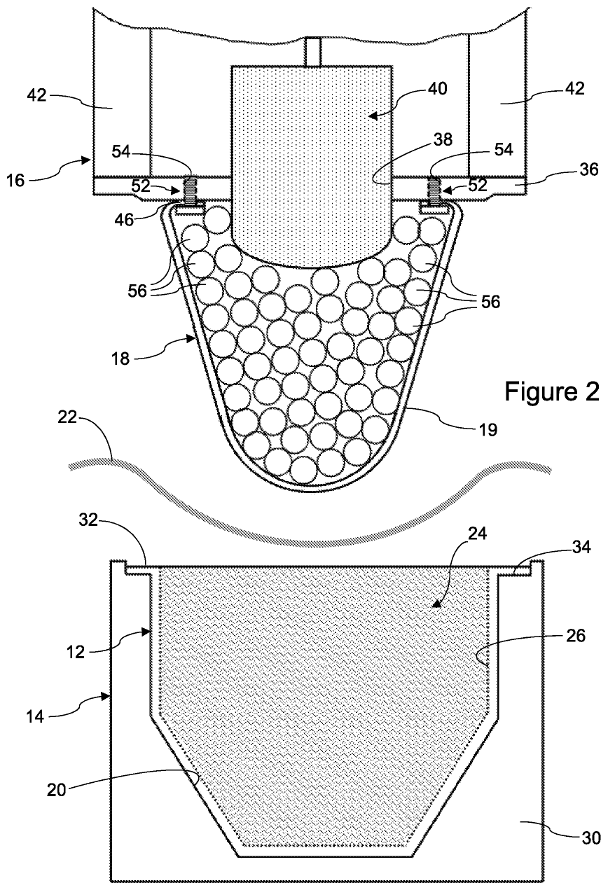

FIG. 2 is a vertical cross-section through the apparatus of FIG. 1, shown in a first configuration;

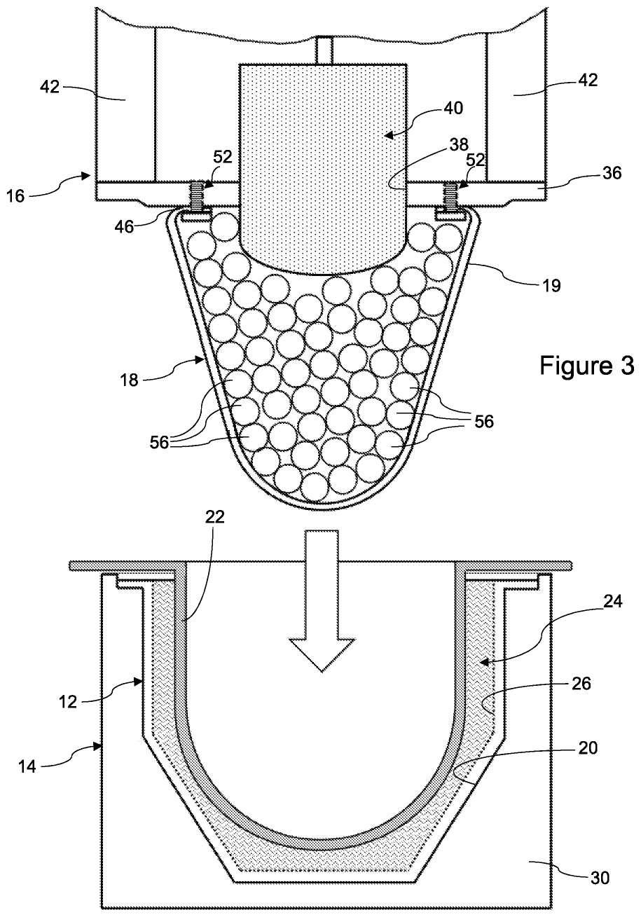

FIG. 3 is a vertical cross-section through the apparatus of FIG. 1, shown in a second configuration, prior to a moulding step;

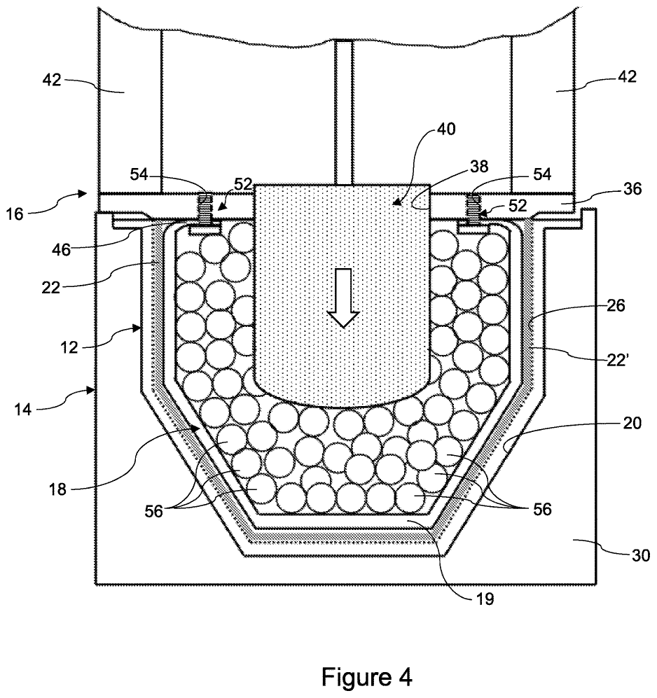

FIG. 4 is a vertical cross-section through the apparatus of FIG. 1, shown in a third configuration, during a moulding step;

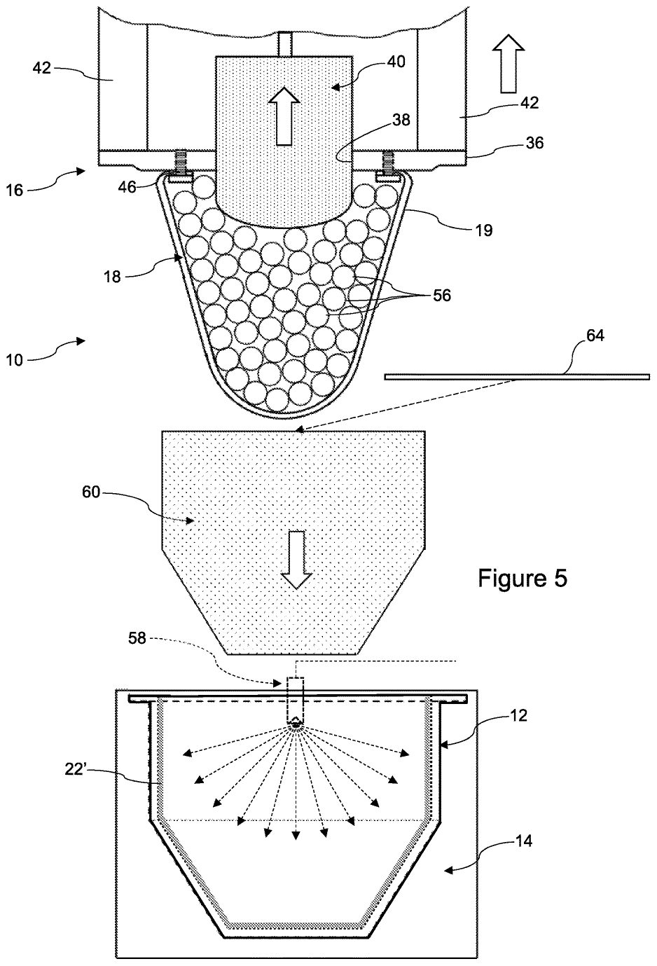

FIG. 5 is a vertical cross-section through the apparatus of FIG. 1, shown after the moulding step, and illustrating the insertion of a pre-made cake base into a moulded layer of icing formed by the apparatus of FIG. 1, to form a cake;

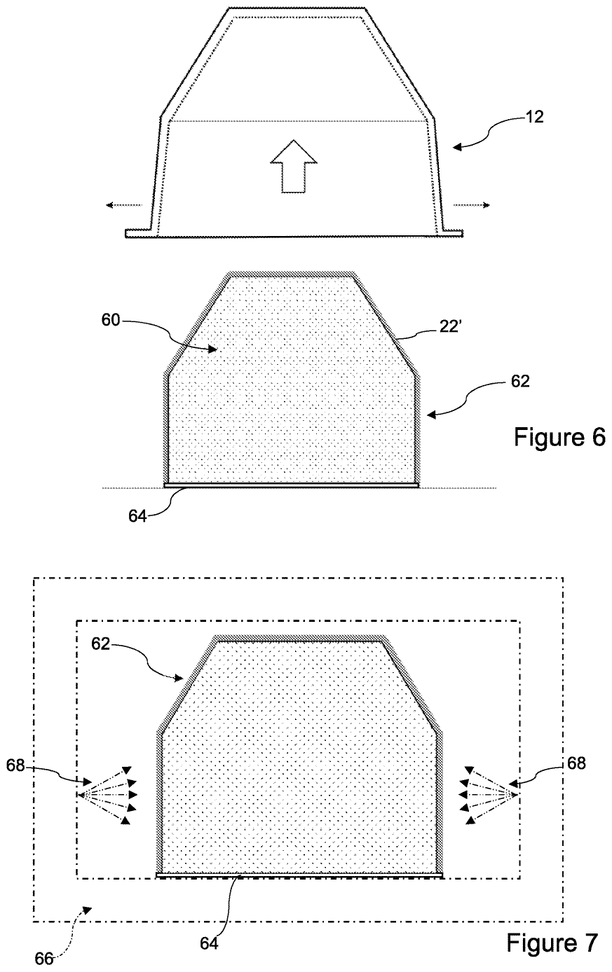

FIG. 6 illustrates removal of a deformable mould from the cake formed after insertion of the cake base into the moulded layer of icing; and

FIG. 7 illustrates an optional chilling step after the mould has been removed from the cake.

The apparatus 10 for producing a moulded decorative layer for a cake comprises a removable, flexible, resiliently deformable mould 12 formed from food grade silicone rubber, a solid mould support 14 for releasably supporting the resiliently deformable mould 12 and a displaceable carriage or support 16 to the lower face of which a resiliently deformable, reversibly expandable enclosure in the form of a bag or bladder 18 formed from food grade silicone rubber is secured. The exterior surface of the resiliently deformable mould 12 is shaped complementarily with an upwardly open recess 20 in the mould support 14.

As will be explained, in use the resiliently deformable removable mould 12 is received in the recess 20 of the mould support 14, a sheet 22 (see FIGS. 2 and 3) of mouldable cake icing is positioned within the interior of the removable mould 12 and the carriage or support 16 is displaced downwardly to position the expandable bag or bladder 18 within the deformable mould 12. The expandable bag or bladder 18 is then expanded to engage the sheet 22 of mouldable cake icing and to press it against the interior surface of the removable mould 12 to impress the shape and pattern of the mould onto the sheet 22 of icing. The moulded sheet of icing is then used to decorate a cake base, as will be explained.

The removable mould 12 formed from food grade silicone rubber is upwardly concave in use, having an upwardly open recess 24 which is shaped to conform generally with the shape of a cake base to be decorated, with some clearance. The enclosing walls of the removable mould 12 have an interior surface 26 defining a moulding surface which can be provided with a profile and/or texture and/or pattern which is intended to be the negative image of the outer surface of the moulded sheet of cake icing. In this particular embodiment, the shape of the recess 24 of the removable mould 12 is shown as being generally the shape of an inverted bell, but the shape of the recess 24 and the profile and/or texture and/or pattern of its interior surface 26 will depend on the shape and appearance of the surface of the cake to be decorated. The outer surface of the removable mould 12 is generally smooth.

The mould support 14 is formed from a solid block 30 which may conveniently be formed from a moulded food grade resin material. The upwardly open recess 20 in the mould support 14 is shaped to be a close complementary fit with the exterior surface of the removable mould 12, such that the outer surface of the removable mould 12 is in close contact with the walls of the open recess 20 when the removable mould 12 is received in the recess 20 of the mould support 14. The upper periphery of the removable mould 12 is provided with a continuous outwardly extending planar peripherally extending lip 32 which, as will be explained, is receivable on a complementary peripherally extending planar shoulder 34 of the mould support 14 located at the upper peripheral edge of the open recess 20.

The carriage or support 16 comprises a base plate 36 having a central circular through hole 38 in which a displacement member in the form of a longitudinally displaceable dome-headed cylindrical piston or plunger 40 is slidably mounted. The base plate 36 is mounted on the lower ends of a plurality of vertically extending parallel frame members 42 which are joined at their upper end by an upper transverse frame member 44. The piston or plunger 40 is displaceable through the hole 38 in both directions along its longitudinal axis by means of a conventional actuator such as a double-acting pneumatic cylinder 46 (shown schematically in FIG. 1) mounted on the upper transverse frame member 44 and the carriage or support 16 is constrained to be displaceable upwards and downwards in a vertical direction by means of one or more conventional actuators such as double-acting pneumatic cylinders 48 (also shown schematically in FIG. 1) mounted on a fixed surface 50.

The head of the piston or plunger 40 projects into the interior of the expandable bag or bladder 18 and is reversibly displaceable longitudinally further into the interior of the bag or bladder 18 by actuating the double-acting pneumatic cylinder 46 mounted on the carriage or support 16. The expandable bag or bladder 18 is formed from a wall 19 of food grade silicone rubber approximately 2 mm thick and is secured to the undersurface of the base plate 36 of the carriage or support 16 by a plurality of equally spaced bolts 52 passing through holes in an inwardly turned peripheral lip 46 of the bag or bladder 18 and being received in a complementarily-threaded recesses 54 in the base plate 36 located outwardly of the through hole 38 in the base plate 36.

As best seen in FIG. 2, the bag or bladder 18 is elongate and is wider at its base than at its end, assuming the shape of a generally inverted frustoconical shape with a rounded apex, when undeformed. The bag 18 defines an internal cavity which contains a plurality of identical spherical balls 56 approximately 5 mm in diameter. In this embodiment the balls are solid and are formed from food grade steel. As will be explained, by moving the piston or plunger 40 further into the interior of the bag or bladder 18, the balls 56 within the bag or bladder 18 are displaced, which causes the bag or bladder to 18 to expand laterally and longitudinally, as the balls 56 are retained within it.

In use, the carriage or support 16 is displaced upwardly to a position (FIG. 1) which allows the removable mould 12 to be inserted into the mould support and seated in the recess 20 (FIG. 2). Then, a sheet 22 of mouldable cake icing or fondant (hereafter referred to as “icing”) is then positioned loosely within the recess 24 of the removable mould 12 and is manipulated and manoeuvred so that it assumes a concave shape which conforms generally to the shape of the interior surface of the removable mould 12 and allows it to be positioned loosely within the mould (FIG. 2). Alternatively, the sheet 22 of mouldable icing can be placed in the mould 12 prior to the mould 12 being positioned in the mould support 14. In either case, the sheet 22 of mouldable icing assumes the configuration shown in FIG. 3.

The carriage or support 16 is then displaced downwardly as indicated in FIG. 3 so that the bag or bladder 18 is received within the recessed sheet 22 of cake icing which is positioned loosely within the mould 12. The downward movement of the carriage or support 16 is limited by engagement of the undersurface of the base plate 36 with the mould 12 and/or the mould support 14, as indicated in FIG. 4, which also helps to trim off excess peripheral portions of the sheet 22 of icing.

The piston or plunger 40 is then displaced downwardly further into the bag or bladder 18 as shown in FIG. 4. The spherical balls 56 are retained within the bag or bladder 18, as the piston or plunger 40 passes closely through the hole 38 in the base plate 36 and prevents the balls 56 from escaping. Consequently, downward displacement of the piston or plunger 40 results in displacement of the spherical balls 56, which in turn causes the bag or bladder 18 to expand outwardly, laterally and longitudinally. This in turn forces the sheet 22 of cake icing outwardly, into contact with the interior moulding surface 26 of the removable mould 12 and the cake icing is squeezed tightly between the outer surface of the expanded bag or bladder 18 and the interior moulding surface 26 of the removable mould 12, as shown in FIG. 4. As the bag or bladder 18 is expanded outwardly by movement of the solid balls 56, the sheet 22 of cake icing is deformed and is forced tightly into engagement with the interior moulding surface 26 of the removable mould 12 and its outer surface is moulded into the negative of the shape and/or texture and/or pattern of the moulding surface 26, forming a moulded sheet 22′ of cake icing.

The piston or plunger 40 is then displaced upwardly, and the resilience of the bag or bladder 18 causes it to retract out of engagement with the moulded sheet 22′ of cake icing, to its undeformed condition. The carriage or support 16 is then displaced upwardly to a position which allows access to the removable mould 12 (FIG. 5).

As shown in dotted lines in FIG. 5, as an optional step a spray head 58 may be positioned within the mould to spray a liquid, such as water or sugar solution, to wet the interior surface of the moulded sheet 22′ of cake icing, to assist in assembling the finished cake, as will be explained.

The spray head 58 (if used) is then removed from the mould and a pre-baked cake base 60 is inserted into the moulded sheet 22′ of icing within the mould 12 to form an assembled cake 62. The cake base 60 can be of any type, for example a baked sponge, fruit cake etc., and is shaped complementarily with the shape of the interior surface of the moulded sheet 22′ of icing. As shown in the Figures, the cake base 60 is inverted prior to insertion, as the mould is upside down as compared with the finished product. If the interior of the moulded sheet 22′ of icing has optionally been sprayed with a liquid from the nozzle 58, the interior surface becomes sticky, which helps to secure the cake base 60 in place.

After the cake base has been inserted, a cardboard or plastics base 64 of the same shape as the exposed portions of the assembled cake 62 is placed over the exposed surface of the cake 62, on which the assembled cake 62 will rest in use.

The mould 12 containing the assembled cake is then removed from the mould support 14 and, as best seen in FIG. 6, the removable mould 12 and the cake 62 within it are inverted and the mould 12 is then removed, leaving the cake 62 resting on the base sheet 64. The mould 12 is formed from flexible, resiliently deformable material, which allows it to be deformed and removed easily from the cake without deforming the cake significantly and at the same time retaining the texture and pattern moulded into the outer surface of the sheet of icing 22′. The use of a mould 12 formed from flexible, resiliently deformable material also allows overhangs to be formed in the moulded sheet of icing 22′ and allows surface patterns of fine detail to be moulded into the exterior surface of the moulded sheet of icing 22′.

Preferably, the cake 62 is then refrigerated to cool the cake in order to firm up the icing and any soft filling components (e.g. buttercream or jam). This might be achieved, for example, by placing the cake 62 in into a blast chiller (indicated schematically at 66, with blasts of chilled air indicated schematically at 68).

Consequently, a decorated cake 62 comprising a cake base 60 and a moulded sheet of icing 22′ is constructed. Subsequent decoration steps such as application of edible colouring and addition of other decoration features (e.g. imitation eyes for a cake which is intended to resemble an animal) can be added, as desired.

The operation to form the moulded sheet of icing 22′ is very quick and repeatable and allows a large number of pre-prepared cake bases to be decorated very quickly.

The invention is not restricted to the details of the foregoing embodiment.

For example, the balls 56 located within the bag or bladder 18 need not be identical, but instead there may be more than one size of ball. Indeed, the balls may be replaced with non-spherical discrete bodies. For example, the bag or bladder 18 may contain solid granular material, which might assist in transferring a finely detailed pattern and/or texture of the moulding surface 26 of the removable mould 12 to the sheet 22 of cake icing. The balls may be made from a material other than food grade steel.

In addition, although the removable mould 12 has been described as being resiliently deformable in the embodiment described above, it would be possible to use a substantially non-deformable mould, for example if the moulded sheet of icing 22′ did not include any overhangs and/or if the surface pattern of the moulded sheet of icing 22′ was relatively smooth.

Furthermore, it will normally be possible to separate the flexible mould 12 from the cake quite easily, as the sheet 22 of icing will normally have a light dusting of cornflour applied to it as it is rolled out, which acts as a mould release agent. However, additional mould release agent may additionally be applied to the exterior of the bag or bladder 18 prior to insertion into the sheet of icing 22, and prior to the moulding step (FIG. 4), to assist demoulding of the cake, if desired. A suitable additional mould release would be a further dusting of cornflour, but other mould release agents may be used.

The cake base 60 described above may also be replaced with other bases, for example a looser cake base material which can be squeezed or extruded into the moulded sheet 22′.

The embodiment described above relates to the formation of a decorative cover layer for a cake base. However, the invention is applicable to other products in which a mouldable layer is to be applied to a base, e.g. a dog food cake comprising a mass of dog food covered with a moulded layer of suet or suet pastry.

The shape of the bag or bladder 18 and/or of the piston or plunger 40 may differ from those shown in the embodiment, depending on the shape of the moulded sheet 22′ of icing to be formed in the mould 12. For example, if the moulded sheet 22′ of icing is elongate, to cover an elongate cake base of a similar shape, then the bag or bladder 18 and/or of the piston or plunger 40 may also be elongate.

Moreover, the chilling step shown in FIG. 7 may, if desired, take place with the cake 62 in situ in the mould 12, and the mould removal step shown in FIG. 6 may take place after the chilling step, i.e. the steps shown in FIGS. 6 and 7 may be reversed with respect to each other.

1. Apparatus for forming a cover layer for a cake base, comprising:
a concave mould comprising inner walls defining a moulding surface;
an expandable enclosure positionable into the mould and comprising a flexible, resiliently deformable wall defining an internal cavity;
a plurality of discrete bodies retained within the internal cavity of the expandable enclosure; and
a displacement member projecting into the interior of expandable enclosure and being reversibly movable within the enclosure to displace the discrete bodies and thereby reversibly expand the flexible, resiliently deformable wall of the expandable enclosure.

2. Apparatus as claimed in claim 1, comprising a mould support comprising a recess for releasably receiving and supporting the mould.

3. Apparatus as claimed in claim 2, wherein the outer surface of the concave mould and the walls of the recess of the mould support are shaped and dimensioned complementarily with each other.

4. Apparatus as claimed in claim 3, wherein when the concave mould is received in the recess of the mould support, the outer surface of the concave mould is in contact with the walls of the recess of the mould support.

5. Apparatus as claimed in any of the preceding claims, wherein the concave mould is resiliently deformable.

6. Apparatus as claimed in claim 5, wherein the concave mould comprises silicone rubber.

7. Apparatus as claimed in any of the preceding claims, comprising a plurality of substantially identical discrete bodies retained within the internal cavity of the expandable enclosure.

8. Apparatus as claimed in any of claims 1 to 6, comprising discrete bodies of different shapes and/or dimensions.

9. Apparatus as claimed in any of the preceding claims, comprising a plurality of spherical discrete bodies.

10. Apparatus as claimed in any of the preceding claims, wherein the expandable enclosure is elongate when undeformed.

11. Apparatus as claimed in claim 10, wherein the expandable enclosure is generally frustoconical when undeformed.

12. Apparatus as claimed in claim 11, wherein the expandable enclosure comprises a rounded head.

13. Apparatus as claimed in any of the preceding claims, further comprising a movable carriage on which the expandable enclosure is mounted.

14. Apparatus as claimed in claim 13, wherein the expandable enclosure is mounted on an undersurface of the movable carriage.

15. Apparatus as claimed in claim 13 or claim 14, wherein the carriage is movable to position the expandable enclosure into the mould.

16. Apparatus as claimed in claim 15, wherein the carriage is movable in both directions along a vertical axis.

17. Apparatus as claimed in any of claims 13 to 16, wherein the displacement member is mounted on the movable carriage.

18. Apparatus as claimed in claim 17, wherein the displacement member passes into the internal cavity of the expandable enclosure through an aperture in the movable carriage.

19. Apparatus as claimed in claim 18, wherein the displacement member is slidably mounted in the aperture in the movable carriage.

20. Apparatus as claimed in any of the preceding claims, wherein the displacement member is generally cylindrical.

21. Apparatus as claimed in claim 20, wherein the displacement member has a rounded head which projects into the internal cavity of the expandable enclosure.

22. A method of forming a cover layer for a cake using apparatus as claimed in any of the preceding claims, the method comprising:
positioning a layer of mouldable cover material within the concave mould;
positioning the expandable enclosure within the mouldable cover material;
moving the displacement member to displace the discrete bodies and thereby expand the flexible, resiliently deformable wall of the expandable container, thereby engaging the layer of mouldable cover material and pressing it into contact with the moulding surface of the mould to form a moulded layer of cover material;
withdrawing the displacement member to allow the flexible, resiliently deformable wall of the expandable container to retract out of engagement with the moulded layer of cover material; and
removing the expandable enclosure from within the moulded layer of cover material.

23. A method of covering a cake base comprising forming a cover layer for a cake as claimed in claim 22 and positioning a cake base within the moulded layer of cover material.

24. A method of covering a cake base as claimed in claim 23, wherein the cake base is positioned in the moulded cover layer while the moulded cover layer is in the mould and wherein the mould is subsequently removed.

25. A method of covering a cake base as claimed in claim 24, wherein the cake base and moulded cover are cooled.
